(19) United States
(12) Patent Application Publication
(10) Pub. No.: US 2026/0081171 A1
(43) Pub. Date: Mar. 19, 2026

(54) ALL-SOLID-STATE BATTERY

(71) Applicant: TDK Corporation, Tokyo (JP)

(72) Inventors: Haruna KATO, Tokyo (JP); Hisashi SUZUKI, Tokyo (JP); Akinobu NOJIMA, Tokyo (JP); Masato KURIHARA, Tokyo (JP)

(73) Assignee: TDK Corporation, Tokyo (JP)

(21) Appl. No.: 19/110,864

(22) PCT Filed: Sep. 27, 2023
(86) PCT No.: PCT/JP2023/035203

§ 371 Date: Mar. 12, 2025

(30) Foreign Application Priority Data
Sep. 28, 2022 (JP) 2022-154971

(51) Int. Cl. H01M 4/62; H01M 4/02; H01M 4/131; H01M 4/133; H01M 4/134

(52) U.S. Cl. CPC H01M 4/628; H01M 4/131; H01M 4/133; H01M 4/134; H01M 2004/027

(57) ABSTRACT

An all-solid-state battery includes a positive electrode layer, a solid electrolyte layer, and a negative electrode layer. A negative electrode mixture layer of the negative electrode layer contains either one or both of a negative electrode active material and a carbon material, a first phase in contact with at least a part of the negative electrode active material and the carbon material, and a second phase in contact with at least a part of the first phase. The first and second phases contain a Li element and an X element which is at least one halogen element selected from the group consisting of F, Cl, Br, and I. An X element concentration in the first phase is higher than in the solid electrolyte layer. An X element concentration in the second phase is lower than the in the first phase and in the solid electrolyte layer.

### TECHNICAL FIELD

The present invention relates to an all-solid-state battery.

The present application claims priority on Japanese Patent Application No. 2022-filed on Sep. 28, 2022, the content of which is incorporated herein by reference.

### BACKGROUND ART

In recent years, in association with an increase in demand for portable electronic devices such as a smartphone and a notebook-sized personal computer, there has been an increase in demand for power storage devices such as a secondary battery that serves as a power source for these portable electronic devices. In addition, there is an increased demand for high-capacity and high-output storage batteries in automobiles and industrial equipment. In recent years, a lithium ion secondary battery with high energy density has been attracting attention. However, a lithium ion secondary battery that is currently on the market uses a flammable organic solvent as an electrolytic solution, which may pose a risk of firing due to a short circuit. In order to solve this safety problem, an all-solid-state battery that is obtained by using, for example, a solid electrolyte instead of an electrolytic solution has been proposed. As the solid electrolyte, a solid battery that is obtained by using an oxide-based solid electrolyte, a sulfide-based solid electrolyte, or a halide-based solid electrolyte has been proposed.

For example, Patent Document 1 and Non Patent Document 1 disclose an all-solid-state battery including a sulfide-based solid electrolyte. Patent Document 1 discloses that in an all-solid-state battery including a sulfide-based solid electrolyte and a negative electrode active material containing a carbon material, the cycle characteristics are improved by providing a lithium salt coat containing fluorine, on the surface of the carbon material. So far, in a lithium ion battery that uses an electrolytic solution and an all-solid-state battery that uses such a sulfide-based solid electrolyte as described above, a large number of studies have been carried out on the effects due to the modification of the surface of the active material,

Non Patent Document 1 discloses that in an all-solid-state battery including a sulfide-based solid electrolyte and a lithium negative electrode, the interface between the sulfide-based solid electrolyte and the lithium negative electrode is stabilized by providing Li₂S, Li₃P or LiX between the lithium negative electrode and the solid electrolyte.

In addition, for example, Patent Document 2 and Non Patent Document 2 disclose an all-solid-state lithium ion battery including a halide-based solid electrolyte. An all-solid-state lithium ion battery carries out charging and discharging by intercalating and deintercalating of lithium ions into and from the positive electrode and the negative electrode. In this case, in the lithium ion all-solid-state battery, the electrode active material expands and contracts, and thus the internal resistance changes. In the all-solid-state battery of Patent Document 2, in order to suppress a change in internal resistance, a technique for covering an active material with a coating layer containing a conductive material and an inorganic solid electrolyte is disclosed. Specifically, the following points are disclosed. A mixed powder of a TiSn alloy powder as negative electrode active material particles, a Li_{3.4}V_{0.6}Si_{0.4}O₄ powder as an inorganic solid electrolyte, and Ketjen black as a conductive material is subjected to a coating treatment in a planetary ball mill. Thereafter, the negative electrode active material powder after the coating treatment, Ketjen black, and a polyvinylidene fluoride powder are thoroughly mixed in acetone to prepare a negative electrode paste. As a result, the surfaces of the negative electrode active material particles are covered with a coating layer, and this coating layer is a layer containing conductive material particles in a homogeneous phase of the solid electrolyte. This negative electrode paste is applied onto a current collector and dried to obtain a negative electrode. In an all-solid-state battery including this negative electrode, a layer containing a hard and glassy solid electrolyte as a main component and having high mechanical strength is used as a coating layer; and therefore, this suppresses changes in battery dimensions caused by the expansion and contraction of the active material in association with charging and discharging, an increase in internal resistance, and deterioration of charging and discharging performance at a large current. As a result, cycle characteristics are improved.

### CITATION LIST

### Patent Documents

[Patent Document 1] Japanese Unexamined Patent Application, First Publication No. 2011-150942
[Patent Document 2] Japanese Unexamined Patent Application. First Publication No. 2003-59495

### Non Patent Document

[Non Patent Document 1]: Electrochem 2021, 2, pages 452 to 471
[Non Patent Document 2]: J. Am. Chem. Soc. 2020, 142, pages 7012 to 7022

### SUMMARY OF INVENTION

### Technical Problem

The oxide-based solid electrolyte, the sulfide-based solid electrolyte, and the halide-based solid electrolyte have characteristics different from each other since they are made of different materials. In recent years, much research has been carried out on a halide-based solid electrolyte as a solid electrolyte having high ion conductivity.

However, a halide-based solid electrolyte having effective characteristics has not yet been studied sufficiently. In such an all-solid-state battery obtained by using a halide-based solid electrolyte as disclosed in Patent Document 2, a reaction with the negative electrode active material should occur during charging. However, a reaction with the solid electrolyte in the vicinity of the negative electrode occurs easily, and due to the decomposition of the solid electrolyte, a compound is formed between a lithium ion in the vicinity of the negative electrode and a cation contained in the solid electrolyte, and this may interrupt a path of lithium ions that flow from the positive electrode into the negative electrode at the negative electrode interface. For this reason, the all-solid-state battery disclosed in Patent Document 2 does not have sufficient cycle characteristics. In addition, as shown in the example of Li₃ScCl₆ (0.92 V vs. Li/Li⁺) in Non Patent Document 2, the potential window on the reduction side tends to be high, and it becomes difficult to use on the negative electrode side, and the interface between the negative electrode active material and the solid electrolyte or the like, and the interface between the negative electrode active material and another material have not been sufficiently examined. As result, cycle characteristics are insufficient.

The present invention has been made in consideration of the above problems, and an object of the present invention is to provide an all-solid-state battery that prevents the decomposition of a solid electrolyte and exhibits excellent cycle characteristics.

### Solution to Problem

In order to solve the above problems, the following solutions are provided.
(1) An all-solid-state battery according to one aspect of the present invention is an all-solid-state battery including:
a power generation element in which a positive electrode layer, a solid electrolyte layer containing a halide-based solid electrolyte represented by Formula (1), and a negative electrode layer are laminated in this order,
wherein the negative electrode layer includes a negative electrode current collector and a negative electrode mixture layer provided on a surface of the negative electrode current collector, the surface facing the positive electrode layer,
the negative electrode mixture layer contains either one or both of a negative electrode active material and a carbon material, a first phase in contact with at least a part of the negative electrode active material and the carbon material, and a second phase in contact with at least a part of the first phase,
the first phase and the second phase contain a Li element and an X element which is at least one halogen element selected from the group consisting of F, Cl, Br, and I,
an X element concentration in the first phase is higher than an X element concentration in the solid electrolyte layer, and
an X element concentration in the second phase is lower than the X element concentration in the first phase and the X element concentration in the solid electrolyte layer.

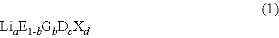

(In Formula (1), E is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Ti, Cu, Nb, Ag, In, Sn, Sb, Ta, W, Au, and Bi, D is at least one group (anion) selected from the group consisting of CO₃, SO₄, BO₃, PO₄, NO₃, SiO₃, OH, and O₂, X is at least one selected from the group consisting of F, Cl, Br, and I, and the following expressions are satisfied: 2≤a<3.5, 0≤b<0.5, 0≤c≤5, and 0<d≤6.1.)
(2) In the all-solid-state battery according to the aspect described in (1) above, the first phase and the second phase may further contain an E element which is at least one element selected from the group consisting of Al, Sc, Y, Zr, Hf, and lanthanoids, and an E element concentration in the second phase may be higher than an E element concentration in the first phase.
(3) In the all-solid-state battery according to the aspect described in (1) or (2) above, the first phase and the second phase may further contain a G element which is at least one element selected from the group consisting of Na, K, Rb, Cs, Mg, Ca, Sr, Ba, B, Si, Ti, Cu, Nb, Ag, In, Sn, Sb, Ta, W, Au, and Bi, and a G element concentration in the second phase may be higher than G element concentrations in the first phase and the solid electrolyte layer.
(4) in the all-solid-state battery according to any one of the aspects described in (1) to (3) above, the first phase and the second phase may further contain a D group which is at least one anion selected from the group consisting of CO₃, SO₄, BO₃, PO₄, NO₃, SiO₃, OH, and O₂, and a D group concentration in the second phase may be higher than D group concentrations in the first phase and the solid electrolyte layer.
(5) In the all-solid-state battery according to any one of the aspects described in (1) to (4) above, each of the first phase and the second phase has a layered structure, the first phase may cover either one or both of the negative electrode active material and the carbon material, and the second phase may cover the first phase.
(6) In the all-solid-state battery according to any one of the aspects described in (1) to (5) above, the negative electrode active material may be at least one selected from graphite, Si, SiOₓ, lithium titanate, and metallic lithium.
(7) In the all-solid-state battery according to any one of the aspects described in (1) to (6) above, the carbon material may be at least one selected from carbon black, graphite, a carbon nanotube, and graphene.
(8) In the all-solid-state battery according to any one of the aspects described in (1) to (7) above, the negative electrode mixture layer may contain the solid electrolyte, and the second phase may be provided between the first phase and the solid electrolyte.

### Advantageous Effects of Invention

According to the above aspect, it is possible to provide an all-solid-state battery that prevents the decomposition of a solid electrolyte and exhibits excellent cycle characteristics.

### BRIEF DESCRIPTION OF DRAWINGS

FIG. 1 A schematic cross-sectional view of an all-solid-state battery according to an embodiment of the present invention.

FIG. 2 A schematic cross-sectional view of the all-solid-state battery according to the embodiment of the present invention, and is an enlarged view of a region surrounded by a broken line in FIG. 1.

FIG. 3 An enlarged view of a vicinity of one negative electrode active material in a negative electrode mixture layer in the all-solid-state battery of FIG. 1.

FIG. 4 An enlarged TEM image of a cross section of an all-solid-state battery of Example 1.

### DESCRIPTION OF EMBODIMENTS

Hereinafter, the present embodiments will be described in detail with reference to the drawings as appropriate. The drawings that are used in the following description may show characteristic portions in an enlarged scale for convenience in order to facilitate the understanding of the characteristics of the present invention, and thus the dimensional ratios or the like of the respective constitutional components may differ from the actual ones. The materials, dimensions, and the like, which are exemplified in the following description, are merely examples, and the present invention is not limited thereto. Therefore, an appropriate modification can be made to implement the present embodiments within the scope that does not change the technical features of the present invention.

### [All-Solid-State Battery]

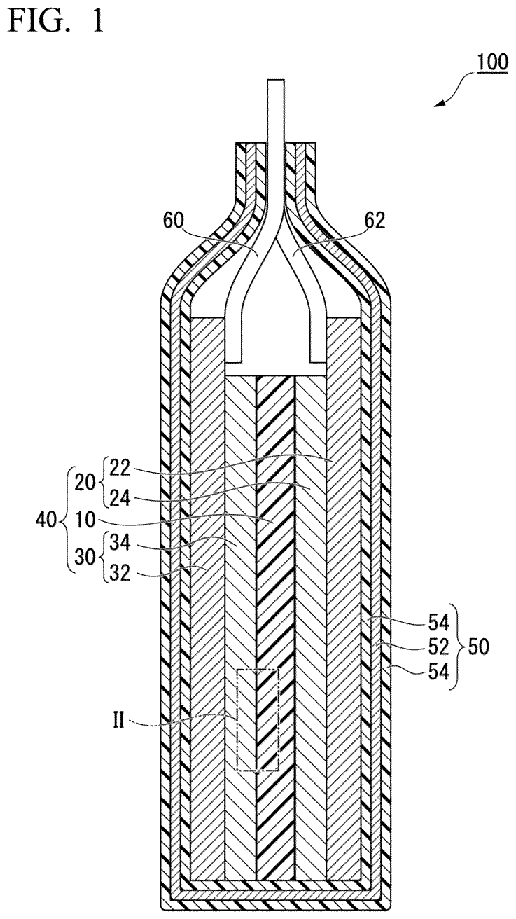

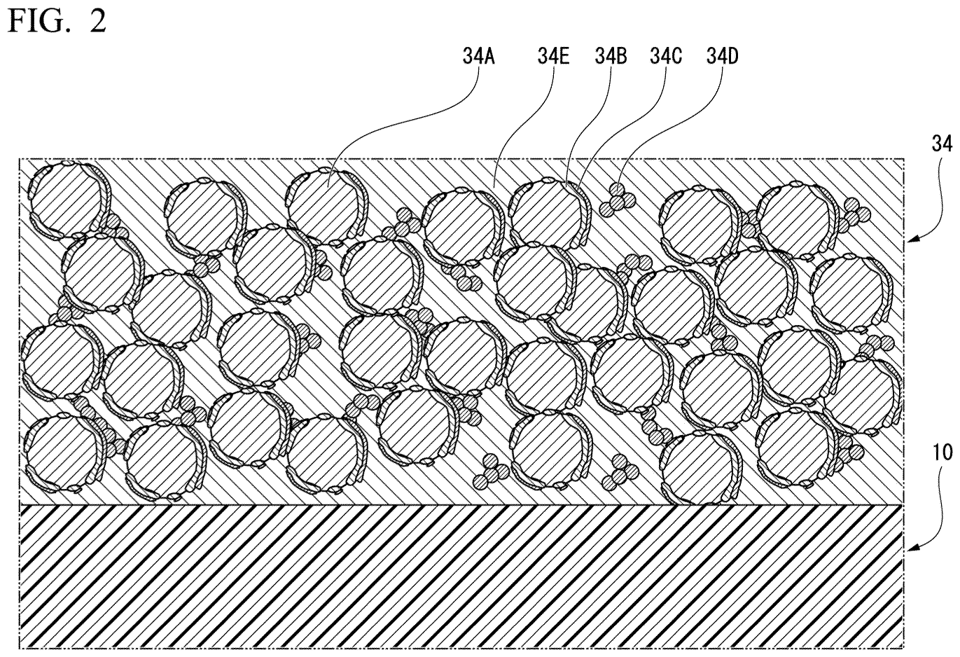

FIG. 1 is a schematic cross-sectional view of an all-solid-state battery 100 according to the present embodiment. FIG. 2 is a schematic cross-sectional view of the all-solid-state battery 100 according to the present embodiment and is an enlarged view of a region surrounded by a two-dot chain line in FIG. 1. The all-solid-state battery 100 is an all-solid-state battery 100 including a power generation element 40 in which a positive electrode layer 20, a solid electrolyte layer 10 containing a halide-based solid electrolyte represented by Formula (1), and a negative electrode layer 30 are laminated in this order. The negative electrode layer 30 includes a negative electrode current collector 32 and a negative electrode mixture layer 34 provided on a surface of the negative electrode current collector 32, and the surface faces the positive electrode layer 20. The negative electrode mixture layer 34 includes a negative electrode active material 34A, a first phase 34B in contact with at least a part of the negative electrode active material 34A, and a second phase 34C in contact with at least a part of the first phase 34B. The first phase 34B and the second phase 34C contain a Li element and an X element which is at least one halogen element selected from the group consisting of F, Cl, Br, and I. An X element concentration in the first phase 34B is higher than an X element concentration in the solid electrolyte layer 10, and an X element concentration in the second phase 34C is lower than the X element concentration in the first phase 34B and the X element concentration in the solid electrolyte layer 10.

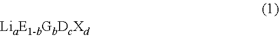

(In Formula (1), E is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Ti, Cu, Nb, Ag, In, Sn, Sb, Ta, W, Au, and Bi, D is at least one group selected from the group consisting of CO₃, SO₄, BO₃, PO₄, NO₃, SiO₃, OH, and O₂, X is at least one selected from the group consisting of F, Cl, Br, and I, and the following expressions are satisfied: 2≤a<3.5, 0≤b<0.5, 0≤c≤5, and 0<d≤6.1.)

The all-solid-state battery 100 shown in FIG. 1 includes a power generation element 40 and an exterior body 50. The exterior body 50 covers the periphery of the power generation element 40. The power generation element 40 is connected to the outside through a pair of connected terminals 60 and 62. Although a laminated type battery is shown in FIG. 1, a wound type battery may also be used. The all-solid-state battery 100 is used, for example, in a laminate battery, a square type battery, a cylindrical battery, a coin type battery, and a button type battery.

### <Power Generation Element>

The power generation element 40 includes the solid electrolyte layer 10, the positive electrode layer 20, and the negative electrode layer 30. The power generation element 40 carries out charging or discharging by the exchange of ions between the positive electrode layer 20 and the negative electrode layer 30 through the solid electrolyte layer 10.

### “Solid Electrolyte Layer”

The solid electrolyte layer 10 is sandwiched between the positive electrode layer 20 and the negative electrode layer 30. The solid electrolyte layer 10 includes a halide-based solid electrolyte that makes it possible to move ions by an externally applied electric field or the like. For example, a solid electrolyte conducts lithium ions and inhibits the movement of elections.

The solid electrolyte is a halide-based solid electrolyte containing lithium, and a compound represented by Formula (I) is used.

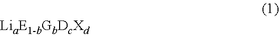

In the compound represented by Formula (I), E is an essential component and is one of the elements that form the skeleton of the compound represented by Formula (I). E is at least one element selected from the group consisting of Al, Sc, Y, Zr, Hf, and lanthanoids (La, Ce, Pr, Nd, Pm, Sin, Eu, Gd, Tb, Dy, Ho, Er, Tm, Yb, and Lu).

By containing E, the solid electrolyte is allowed to have a wide potential window and high ion conductivity. E preferably includes Al, Sc, Y, Zr, Hf, or La, and it is particularly preferable that E includes Zr or Y since the solid electrolyte is allowed to have higher ion conductivity.

In the compound represented by Formula (I), G is a component that is contained as necessary. G is at least one element selected from the group consisting of Na, K, Rb, Cs, Mg, Ca, Sr, Ba, B, Si, Ti, Cu, Nb, Ag, In, Sn, Sb, Ta, W, Au, and Bi. In the compound represented by Formula (1), G may be, among those described above, a monovalent element selected from Na, K, Rb, Cs, Ag, and Au. In the compound represented by Formula (1), G may be, among those described above, a divalent element selected from Mg, Ca, Sr, Ba, Cu, and Sn. In the compound represented by Formula (1), G may be, among those described above, a trivalent element selected from B, Si, Ti, Nb, In, Sb, Ta, W, and Bi.

In the compound represented by Formula (I), D is a component that is contained as necessary. D is at least one group selected from the group consisting of CO₃, SO₄, BO₃, PO₄, NO₃, SiO₃, OH, and O₂. By containing D, the potential window on the reduction side becomes wider. D is preferably at least one group selected from the group consisting of SO₄ and CO₄, and it is particularly preferable that D is SO₄.

In the compound represented by Formula (1), X is an essential component and is one of the elements that form the skeleton of the compound represented by Formula (1). X is at least one or more halogen elements selected from the group consisting of F, Cl, Br, and I. X has a large ionic radius per valence. Therefore, in a case where the compound represented by Formula (1) contains X, the lithium ion is more likely to be mobile, and an effect that the ion conductivity increases can be obtained. X preferably contains Cl, since this results in a solid electrolyte having high ion conductivity.

In the compound represented by Formula (1), a, b, c, and d are numbers that satisfy 2≤a<3.5, 0≤b<0.5, 0≤c≤5, and 0<d≤6.1, respectively. It is preferable that the following expressions are satisfied: 2≤a<3.0, 0≤b<0.35, 0≤c≤3, and 1.5<d≤6.1.

Examples of the compound represented by Formula (1) include Li₂ZrCl₆, Li₂ZrSO₄Cl₄, Li₂ZrCO₃Cl₄, Li₃YSO₄Cl₄, Li₃YCO₃Cl₄, Li₂ZrSO₄Cl_{43.9}F_{0.1}, Li₂ZrSO₄Cl_{43.9} Br_{0.1}, and Li₇ZrSO₄Cl_{43.8}I_{0.2}.

### (Positive Electrode)

As shown in FIG. 1, the positive electrode layer 20 is a positive electrode layer in which a positive electrode mixture layer 24 is provided on a plate-shaped (foil-shaped) positive electrode current collector 22. The positive electrode layer 20 is disposed so that the positive electrode mixture layer 24 is adjacent to the solid electrolyte layer 10 and faces the negative electrode layer 30 described below.

### (Positive Electrode Current Collector)

The positive electrode current collector 22 needs only to be made of a material having electron conductivity, which is resistant to oxidation during charging and is resistant to corrosion. As the positive electrode current collector 22, for example, a metal such as aluminum, stainless steel, nickel, or titanium, or a conductive resin can be used. The positive electrode current collector 22 may be in any form of a powder, a foil, being punched, or being expanded.

### (Positive Electrode Mixture Layer)

The positive electrode mixture layer 24 contains a positive electrode active material and contains, as necessary, a solid electrolyte, a binder, and a conductive auxiliary agent.

### (Positive Electrode Active Material)

The positive electrode active material needs only to be a positive electrode active material that is capable of reversibly advancing occlusion and release of lithium ions and the intercalation and deintercalation of lithium ions, and the positive electrode active material is not particularly limited. As the positive electrode active material, a positive electrode active material that is used in a publicly known lithium ion secondary battery can be used. Examples of the positive electrode active material include a lithium-containing metal oxide and a lithium-containing metal phosphorus oxide.

Examples of the lithium-containing metal oxide include lithium cobaltate (LiCoO₂), lithium nickelate (LiNiO₂), lithium manganese spinel (LiMn₂O₄), a composite metal oxide represented by a general formula: LiNiₓ Co_{y}Mn_{z}O₂ (x+y+z=1), a lithium-vanadium compound (LiVOPO₄ or Li₃V₂(PO₄)₃), an olivine-type LiMPO₄(M represents at least one selected from Co, Ni, Mn, and Fe), and lithium titanate (Li₄Ti₅O₁₂).

In addition, a positive electrode active material that does not contain lithium can also be used. Examples of this positive electrode active material include a non-lithium-containing metal oxide (such as MnO₂ or V₂O₅), a non-lithium-containing metal sulfide (such as MoS₂), and a non-lithium-containing fluoride (such as FeF₃ or VF₃).

In a case of using these positive electrode active materials that do not contain lithium, the negative electrode may be doped with lithium ions in advance, or a negative electrode containing lithium ions may be used.

### (Binder)

The binder binds the materials constituting the positive electrode mixture layer 24 to each other. In addition, the binder also adheres the positive electrode mixture layer 24 to the positive electrode current collector 22. The characteristics required for the binder include oxidation resistance and good adhesiveness.

Examples of the binder that is used in the positive electrode mixture layer 24 include polyvinylidene fluoride (PVDF) or a copolymer thereof, polytetrafluoroethylene (PTFE), polyamide (PA), polyimide (PI), polyamideimide (PAI), polybenzimidazole (PBI), polyether sulfone (PES), polyacrylic acid (PA) or a copolymer thereof, a metal ion crosslinked product of polyacrylic acid (PA) or a copolymer thereof, polypropylene (PP) grafted with maleic anhydride, polyethylene (PE) grafted with maleic anhydride, and a mixtures thereof. Among these, it is particularly preferable to use PVDF as the binder.

The amount of the binder in the positive electrode mixture layer 24 is not particularly limited; however, it is preferably 1% by volume to 15% by volume and more preferably 3% by volume to 5% by volume based on the sum of volumes of the positive electrode active material, the solid electrolyte, the conductive auxiliary agent, and the binder. In a case where the amount of the binder is too low, it tends not to be possible to form a positive electrode layer 20 having sufficient adhesive strength. In addition, a general binder is electrochemically inactive and thus does not contribute to the discharge capacity. For this reason, in a case where the amount of the binder is too high, it tends to be difficult to obtain a sufficient volume energy density or mass energy density.

### (Conductive Auxiliary Agent)

The conductive auxiliary agent is not particularly limited as long as it improves the electron conductivity of the positive electrode mixture layer 24, and any publicly known conductive auxiliary agent can be used. Examples thereof include a carbon material such as carbon black, graphite (natural graphite or artificial graphite), a carbon nanotube, or graphene, a metal such as aluminum, copper, nickel, stainless steel, iron, or an amorphous metal, a conductive oxide such as ITO, and a mixture thereof. The conductive auxiliary agent may be in any form of a powder or a fiber.

The amount of the conductive auxiliary agent in the positive electrode mixture layer 24 is not particularly limited. In a case where the positive electrode mixture layer 24 contains a conductive auxiliary agent, the amount of the conductive auxiliary agent is preferably 0.5% by volume to 20% by volume, and more preferably 1% by volume to 10% by volume, based on the sum of volumes of the positive electrode active material, the solid electrolyte, the conductive auxiliary agent, and the binder.

### (Negative Electrode)

The negative electrode layer 30 includes a negative electrode current collector 32 and a negative electrode mixture layer 34 provided on a surface among the surfaces of the negative electrode current collector 32, and the surface faces the positive electrode layer 20. The negative electrode mixture layer 34 includes either one or both of a negative electrode active material 34A and a carbon material 34D, a first phase 34B in contact with at least a part of the negative electrode active material 34A and the carbon material 34D, and a second phase 34C in contact with at least a part of the first phase 348.

In the present embodiment, the negative electrode mixture layer 34 includes both the negative electrode active material 34A and the carbon material 34D, and the first phase 34B is in contact with at least a part of the negative electrode active material 34A.

### (Negative Electrode Current Collector)

The negative electrode current collector 32 only needs to have electron conductivity. The negative electrode current collector 32 is made of, for example, a metal such as copper, aluminum, nickel, stainless steel, or iron, or a conductive resin. The negative electrode current collector 32 may be in any form of a powder, a foil, being punched, or being expanded.

### (Negative Electrode Mixture Layer)

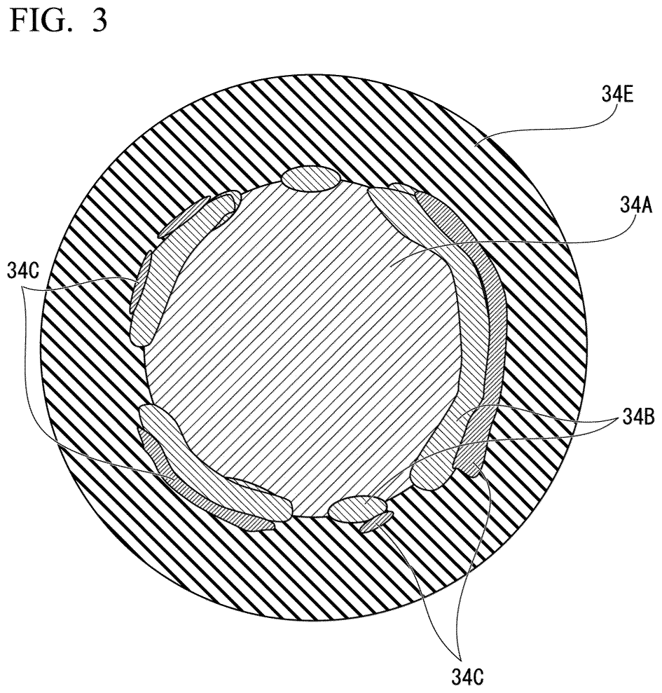

The negative electrode mixture layer 34 contains the negative electrode active material 34A, the carbon material 34D, the first phase 34B the second phase 34C, and a solid electrolyte 34E. The solid electrolyte 34E is contained as necessary, and the solid electrolyte 34E may not be contained. The negative electrode mixture layer 34 further contains a binder and a conductive auxiliary agent as necessary. As the binder and the conductive auxiliary agent, publicly known ones can be used. The conductive auxiliary agent may be, for example, a metal. The solid electrolyte 34, is, for example, a solid electrolyte similar to the solid electrolyte that is contained in the solid electrolyte layer 10. That is, the solid electrolyte 34E is, for example, a solid electrolyte represented by Formula (1) described above. The second phase 34C′ is provided, for example, between the first phase 34B and the solid electrolyte 34E and is in contact with at least a part of the first phase 34B. FIG. 3 is an enlarged schematic view of the vicinity of one negative electrode active material 34A in the negative electrode mixture layer 34. FIG. 2 shows a configuration in which the entire surface of the negative electrode active material 34A is covered with the first phase 34B, and the entire surface of the first phase 34B is covered with the second phase 34C. However, the present embodiment is not limited to thereto, and as shown in an enlarged view in FIG. 3, it may have a configuration in which a part of the surface of the negative electrode active material 34A is covered with the first phase 34B, and a part of the surface of the first phase 34B is covered with the second phase 34C.

### Negative Electrode Active Material

The negative electrode active material 34A needs only to be capable of reversibly advancing occlusion and release of lithium ions and the intercalation and deintercalation of lithium ions, and the negative electrode active material 34A is not particularly limited. For the negative electrode active material 34A, a material that is used in a publicly known lithium ion secondary battery can be used.

The negative electrode active material 34A is, for example, a carbon material such as graphite (natural graphite or artificial graphite), a mesocarbon microbead, a mesocarbon fiber (MCF), cokes, glassy carbon, or a sintered body of an organic compound, a metal capable of forming a compound with lithium, such as Si, SiOₓ, Sn, or aluminum, an alloy thereof, a composite material of these metals and a carbon material, an oxide such as lithium titanate (Li₄Ti₅O₁₂) or SnO₂, or metallic lithium. The negative electrode active material 34A is preferably at least one selected from graphite, Si, SiOₓ, lithium titanate (Li₄Ti₅O₁₂), and metallic lithium.

### Carbon Material

The carbon material 34D functions as a conductive auxiliary agent and also functions as a negative electrode active material. The carbon material 34D is a vapor growth carbon fiber (VGCF), carbon black, graphite, a carbon nanotube, graphene, or the like. The carbon material 34D is preferably one or more selected from carbon black, graphite, a carbon nanotube, and graphene.

### First Phase

The first phase 34B contains a Li element and an X element which is at least one halogen element selected from the group consisting of F, Cl, Br, and I. An X element concentration in the first phase 34B is higher than an X element concentration in the solid electrolyte layer 10. The X element concentration in the first phase 34B is, for example, more than 1 time and 15 times or less with respect to the X element concentration in the solid electrolyte layer 10, and it is preferably more than 1 time and 8 times or less, and more preferably 1.2 times or more and 6.8 times or less. Hereinafter, the element concentration of any element means concentration in terms of mass percent.

### Second Phase

The second phase 34C, contains a Li element and an X element which is at least one halogen element selected from the group consisting of F, Cl, Br, and I. The second phase 34C contains, for example, the X element of the same element species as that of the first phase 34B. An X element concentration in the second phase 34C is lower than the X element concentration in the first phase 34B and the X element concentration in the solid electrolyte layer 10. The X element concentration in the second phase 34C is, for example, 0.1 times or more and less than 1 time with respect to the X element concentration in the solid electrolyte layer 10, and it is preferably 0.3 times or more and less than 1 time, and more preferably 0.5 times or more and less than 0.98 times. The second phase 34C, is sandwiched between, for example, the solid electrolyte 341 and the first phase 34B in the negative electrode mixture layer 34, or between the solid electrolyte in the solid electrolyte layer 10 and the first phase 34B.

The first phase 34B is in contact with, for example, at least a part of the surface of the negative electrode active material 34A, and it may be in contact with the entire surface of the negative electrode active material 34A or may cover the entire surface of the negative electrode active material 34A.

The first phase 34B and the second phase 34C may further contain an E element which is at least one element selected from the group consisting of Al, Sc, Y, Zr, Hf, and lanthanoids, and the E element concentration in the second phase 34C may be higher than the E element concentration in the first phase 34B.

The first phase 34B and the second phase 34C may further contain a G element which is at least one element selected from the group consisting of Na, K. Rb, Cs, Mg, Ca. Sr, Ba, B, Si, Ti, Cu, Nb, Ag, In, Sn, Sb, Ta, W, Au, and Bi, and the G element concentration in the second phase 34C may be higher than the G element concentrations in the first phase 34B and the solid electrolyte layer 10.

The first phase 34B and the second phase 34C may further contain a D group which is at least one group (anion) selected from the group consisting of CO₃, SO₄, BO₃, PO₄, NO₃, SiO₃, OH, and O₂, and the D group concentration in the second phase may be higher than the D group concentrations in the first phase 34B and the solid electrolyte layer 10.

The first phase 34B and the second phase 34C each have, for example, a layered structure. The layered structure may be discontinuous or may be continuous. In addition, each of the first phase 34B and the second phase 34C may be locally formed in a particulate shape. The thickness of the second phase 34C is, for example, 1/10 times or more and ½ times or less with respect to the thickness of the first phase 34B. The thicknesses of the first phase 34B and the second phase 34C are calculated as the average thicknesses at ten locations of the negative electrode active material 34A in each of the first phase 34B and the second phase 34C which are in contact with ten pieces of the negative electrode active material 34A in the cross-sectional image of the negative electrode mixture layer 34.

As described above, the first phase 341 may cover at least a part of the negative electrode active material 34A. The first phase 34B preferably covers more than 50% and 100% or less of the region of the surface of the negative electrode active material 34A in a cross section obtained by cutting the negative electrode mixture layer 34 along the lamination direction. That is, a part of the surface of the negative electrode active material 34A in the negative electrode mixture layer 34 is an exposed area that is exposed, and it may be a covered region, a part of which is in contact with the first phase 34B, or the negative electrode active material 34A may be a covered region in which the entire surface of the negative electrode active material 34A is in contact with the first phase 34B. In a case where the first phase 34B is a material having lithium ion conductivity, the ion paths of the lithium ions are not lost even in a case where the entire surface of the negative electrode active material 34A is covered with the first phase 34B. Hereinafter, this configuration may be referred to as a coverage rate of the first phase 34B with respect to the negative electrode active material 34A. In a case where the coverage rate of the first phase 34B with respect to the surface of the negative electrode active material 34A on the positive electrode layer 20 side is within the above-described range, the effect of suppressing the reduction of the negative electrode active material 34A is likely to be easily obtained in the covered region.

As described above, the second phase 34C is in contact with at least a part of the first phase 34B.

A cross-sectional image of the negative electrode mixture layer 34 can be checked, for example, with a scanning electron microscope (SEM) or a transmission electron microscope (TEM). The coverage rates of the phases having compositions corresponding to the first phase 34B and the second phase 34C may change due to the first charging and discharging. The above-described coverage rate of the first phase and the coverage rate of the second phase are values before the first charging and discharging.

### <Exterior Body>

The exterior body 50 houses the power generation element 40 in the inside thereof. The exterior body 50 prevents the infiltration of moisture and the like from the outside to the inside. As shown in FIG. 1, the exterior body 50 includes, for example, a metal foil 52 and a resin layer 54 laminated on each side of the metal foil 52. The exterior body 50 is a metal laminate film that is obtained by coating both sides of the metal foil 52 with a polymer film (resin layer 54).

The metal foil 52 is, for example, an aluminum foil or a stainless steel foil. For the resin layer 54, for, example, a polymer film such as polypropylene can be used. The material that constitutes the resin layer 54 may be different between the inner side and the outer side. For example, as a material of the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

Terminals 62 and 60 are connected to the positive electrode layer 20 and the negative electrode layer 30, respectively. The terminal 60 connected to the positive electrode layer 20 is a positive electrode terminal, and the terminal 62 connected to the negative electrode layer 30 is a negative electrode terminal. The terminals 60 and 62 are responsible for electrical connection to the outside. The terminals 60 and 62 are formed from a conductive material such as aluminum, nickel, copper, or the like. The connection method may be welding or screwing. The terminals 60 and 62 are preferably protected with insulating tape to prevent a short circuit.

[Method for Manufacturing all-Solid-State Battery]

Next, a method for manufacturing the all-solid-state battery according to the present embodiment will be described.

An all-solid-state battery can be manufactured, for example, by using a powder molding method. In a method for manufacturing an all-solid-state battery which uses a powder molding method, for example, first, a resin holder having a through hole in the center, a lower punch, and an upper punch are prepared. The diameter of the through hole of the resin holder is, for example, 9.99 mm. A lower punch is inserted from the lower part of the through hole of the resin holder, and a powdered solid electrolyte is charged from the opening side of the resin holder. Next, an upper punch is inserted on the charged powdered solid electrolyte, and these are placed on a pressing machine, and the charged powdered solid electrolyte is pressed. The pressing force is, for example, 24 tons. The powdered solid electrolyte is pressed with the upper punch and the lower punch in the resin holder to form the solid electrolyte layer 10.

The powdered solid electrolyte can be obtained by mixing raw material powders at predetermined molar ratios so that a desired composition is obtained, and then carrying out a reaction. There is no particular restriction on the reaction method. However, a mechanochemical milling method, a sintering method, a melting method, a liquid phase method, a solid phase method, or the like can be used.

Next, the upper punch is temporarily removed, and a material of the positive electrode mixture layer is charged on the upper punch side of the solid electrolyte. Thereafter, the upper punch is inserted again, and pressing is carried out. The pressing force is set to, for example, the same size as described above. The material of the positive electrode mixture layer is pressed to form the positive electrode mixture layer 24.

Next, the lower punch is temporarily removed, and a material of the negative electrode mixture layer is charged on the lower punch side of the solid electrolyte layer. The material of the negative electrode mixture layer is charged, for example, by turning the specimen upside down and charging the material of the negative electrode mixture layer onto the solid electrolyte.

In the present embodiment, the material of the negative electrode mixture layer is prepared, for example, by the following method. The material of the negative electrode mixture layer is prepared, for example, as follows. First the negative electrode active material, the carbon material, and the solid electrolyte are mixed by using an agate mortar and an agate pestle to obtain a mixed powder, Next, a powder of a compound including a lithium element and a halogen element is added to this mixed powder, and a mixture is further mixed to prepare a material of the negative electrode mixture layer. The compound including a lithium element and a halogen element is, for example, a compound represented by LiX. The X element is at least one halogen element selected from the group consisting of F, Cl, Br, and I.

Next, the lower punch is inserted again, and pressing is carried out. The pressing force is set to, for example, the same as described above, in this way, a laminate including a positive electrode mixture layer, a solid electrolyte layer, and a negative electrode mixture layer of the power generation element 40 can be formed through the treatment which will be described below.

Next, for example, an insulating resin sheet having a through hole capable of accommodating the above-described laminate in the center is prepared, and the laminate is inserted so that the end surfaces of the laminate are exposed. Next, each of metal foils that serves as a positive electrode current collector or a negative electrode current collector is disposed and fixed on each of the end surfaces of the laminate, respectively; and thereby, a solid-state battery cell is produced. Terminals are attached to the positive electrode current collector and the negative electrode current collector of the obtained solid-state battery cell, the solid-state battery cell is housed in an aluminum laminated bag so that the terminals thereof are exposed, and then the solid-state battery cell is sealed therein to produce a sealed cell in which the all-solid-state battery cell is housed in an exterior body.

In the present embodiment, the sealed cell is subjected to a heat treatment. The heat treatment for the sealed cell can be carried out, for example, at a temperature of 40° C. or more and 55° C. or less for a period of 0.5 hours or more and 2 hours or less. In a case of carrying out the heat treatment under such conditions, it is possible to produce the all-solid-state battery 100 according to the above-described embodiment, in which the first phase is formed on at least a part of the surface of the negative electrode mixture and the second phase is formed on at least a part of the surface of the first phase.

In the all-solid-state battery 100 according to the present embodiment, the negative electrode mixture layer 34 includes such a first phase MB and second phase 34C as described above, and thus it is possible to suppress the reduction of the solid electrolyte contained in the solid electrolyte layer 10 in the periphery of the negative electrode layer 30, by lithium ions that flow from the positive electrode layer 20 into the negative electrode layer 30 during charging. That is, in the all-solid-state battery 100 according to the present embodiment, the reduction of the negative electrode active material 34A during charging is not inhibited by the reduction of the solid electrolyte contained in the solid electrolyte layer 10. As a result, the all-solid-state battery 100 according to the present embodiment makes it possible to increase the discharge capacity and the reversible capacity.

It is considered that the reason why the all-solid-state battery 100 according to the present embodiment can obtain the above-described effects is due to the presence of the first phase 34B and the second phase 34C. Since the negative electrode mixture layer 34 includes the first phase 34B and the second phase 34C, the potential of the solid electrolyte in the periphery of the negative electrode layer 30 becomes lower. Therefore, it is considered that the reactivity of the solid electrolyte in the periphery of the negative electrode layer 30 with the lithium ions that flow from the positive electrode layer 20 into the negative electrode layer 30 during charging decreases.

In addition, since the halide-based solid electrolyte that is used in the present embodiment has high ion conductivity, the all-solid-state battery 100 has high ion conductivity. In addition, in the all-solid-state battery 100 according to the present embodiment, the first phase in contact with at least a part of the negative electrode active material and the second phase in contact with at least a pan of the first phase are included, and the first phase and the second phase include predetermined compositional elements. Thereby, it is possible to prevent the reductive decomposition of the solid electrolyte; and as a result, the all-solid-state battery 100 according to the present embodiment also has excellent cycle characteristics.

It is noted that in the above-described embodiment, although a configuration in which a plurality of regions are arranged in a direction intersecting the lamination direction is shown for the second phase 34C, the second phase 34C may be an integral layered member.

As described above, the embodiments of the present invention have been described in detail with reference to the drawings. However, each of the configurations and the combination thereof in each embodiment are examples, and additions, omissions, substitutions, and other modifications of the configuration of the present embodiment can be made without departing from the technical features of the present invention.

For example, in FIG. 2, although the first phase 34B is in contact with at least a part of the negative electrode active material 34A, the first phase 34B may be in contact with at least a part of the carbon material 34D. The first phase 34B may cover the entire surface of the carbon material 34D, or the first phase 34B may cover only a part of the surface of the carbon material 34D.

In addition, in FIG. 2, although the negative electrode mixture layer 34 includes both the negative electrode active material 34A and the carbon material 34D, the negative electrode mixture layer 34 may have any one of the negative electrode active material 34A or the carbon material 34D.

### EXAMPLES

### Example 1

### (1) Preparation of Solid Electrolyte Pellet

As a solid electrolyte, a Li₂ZrCl₆ powder was prepared, and a pellet making jig was used to prepare a solid electrolyte pellet. Specifically, first, a resin holder having a diameter of 10 mm and including die steel (SKD material), and an upper punch and a lower punch each having a diameter of 9.99 mm were prepared as the pellet making jig. Next, the lower punch was inserted into the resin holder of this pellet making jig, and a solid electrolyte was charged onto the top of the lower punch. Next, the upper punch was inserted on the solid electrolyte. Next, this pellet making jig was placed on a pressing machine, and pressurization was carried out at a molding pressure of 24 tons. In this way, a solid electrolyte pellet was prepared.

### (2) Preparation of Mixture

### (2-1) Preparation of Positive Electrode Mixture

Next, a positive electrode mixture was prepared. Specifically, lithium cobaltate (LiCoO₂), the solid electrolyte (Li₂ZrCl₆) obtained in (1) above, and graphite (C) were weighed out at a weight ratio of LiCoO₂:Li₂ZrCl₆:C=62:35:3, and the resultant mixture was mixed for 15 minutes using an agate pestle and agate mortar to obtain a positive electrode mixture.

### (2-2) Preparation of Negative Electrode Mixture

Next, a negative electrode mixture was prepared. Specifically, graphite (C) and a solid electrolyte (Li₂ZrCl₆) were weighed out at a weight ratio of C:Li₂ZrCl₆=60:40, the resultant mixture was mixed for 15 minutes using an agate pestle and agate mortar, LiCl was further added thereto so that an amount thereof was 0.5 wt %, and mixing was further carried out for 5 minutes to obtain a negative electrode mixture.

### (3) Preparation of Cell

Next, the solid electrolyte pellet was inserted into a resin holder of the pellet making jig, and the negative electrode mixture was charged onto one surface of the solid electrolyte pellet. Next, the resin holder was vibrated to make the negative electrode mixture have an even surface. Next, a lower punch was inserted on the negative electrode mixture to smooth the surface of the negative electrode mixture. Next, the direction of the solid electrolyte pellet was reversed, the positive electrode mixture was charged onto the other surface of the solid electrolyte pellet, and the positive electrode mixture was made to have an even surface in the same manner as in the case of the negative electrode mixture. Next, an upper punch was inserted on the positive electrode mixture to smooth the surface of the positive electrode mixture.

Next, the pellet making jig in which the negative electrode mixture, the solid electrolyte pellet, and the positive electrode mixture were accommodated in the resin holder in this order was placed on a pressing machine, and pressurization was carried out at a molding pressure of 24 tons. Next, the upper punch was temporarily removed to produce a laminate in which, in this way, the negative electrode mixture pellet, the solid electrolyte pellet, and the positive electrode mixture pellet were laminated in this order. Next, the laminate of the negative electrode mixture pellet, the solid electrolyte pellet, and the positive electrode mixture pellet was subjected to a heat treatment step of holding the laminate for 1 hour in a constant temperature chamber at 45° C.; and thereby, a cell according to Example 1 was produced.

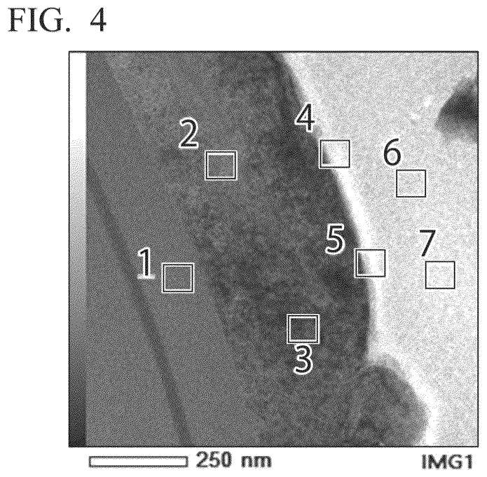

The cell produced by the above-described procedure was sliced in an environment not exposed to the atmospheric air, and then an electron microscope image was obtained using a transmission electron microscope (TEM). FIG. 4 shows a TEM image of a cross section of the cell of Example 1, which is obtained by enlarging the vicinity of the negative electrode mixture layer. In Example 1, the elemental analysis and the compositional analysis were carried out by STEM-EDS using the TEM, the presence of Li was checked by STEM-EELS, and the crystallinity was evaluated by TEM-ED.

Specifically, for the elemental analysis and the compositional analysis, a measurement specimen was sampled from a cross section of the sliced cell so that the solid electrolyte layer (solid electrolyte pellet) and the negative electrode mixture layer (negative electrode mixture pellet) were included in the same measurement field of view as that of the STEM-EDS. The line analysis (elemental analysis and compositional analysis) for the solid electrolyte layer, and the solid electrolyte, the first phase, and the second phase in the negative electrode mixture layer was carried out by STEM-EDS under the same conditions in the same measurement field of view.

In the STEM-EELS measurement results, a Li—K absorption spectrum had two main peaks in the vicinity of 62 eV and in the vicinity of 69 eV. Therefore, in a case where a Li—K absorption spectrum having these two main peaks was confirmed, it was determined that the Li element was contained.

In the evaluation of crystallinity by TEM-ED, it was determined that crystallinity was provided in a case where diffraction spots (spots) were confirmed.

As a result of the measurements, the presence of the Li element was also confirmed in all of the regions indicated by the reference numeral 1 to the reference numeral 7 in FIG. 4. In addition, the results (wt %) of the elemental analysis and the compositional analysis of the regions indicated by the reference numeral 1 to the reference numeral 7 are summarized in Table 1. It is noted that Li cannot be detected by EDS. In Table 1, the relative amount of each element is shown while the total amount of elements excluding Li is set to 100%. In addition, in Table 1, “-” indicates that the element was not identified. In this way, in the cell of Example 1, four layers having compositions clearly different from each other were confirmed as shown in FIG. 4. In addition, it was confirmed that, in FIG. 4, a region indicated by the reference numeral 1 was the negative electrode active material, regions indicated by the reference numerals 2 and 3 were the first phase, regions indicated by the reference numerals 4 and S were the second phase, and regions indicated by the reference numerals 6 and 7 were the solid electrolyte (corresponding to the reference numeral 34E in FIG. 2).

The results (line profile) of the line analysis by STEM-EDS are shown as a graph that is obtained such that the horizontal axis indicates the moving distance of the measurement point (the position of the measurement point) and the vertical axis indicates the detection intensity (the amount of element). In this line profile, regions having approximately the same detection intensity (amount of element) were determined to be any of the four layers, and the inflection point in the graph was defined as the layer boundary.

TABLE 1

| Element | Region 1 | Region 2 | Region 3 | Region 4 | Region 5 | Region 6 | Region 7 |
|---|---|---|---|---|---|---|---|
| C | 97.28 | 2.16 | — | 3.21 | 3.57 | 3.15 | 3.03 |
| O | 1.14 | 5.83 | 6.34 | 30.39 | 30.5 | 26.21 | 26.03 |
| S | 0.17 | 0.88 | 1.85 | 8.67 | 8.31 | 8.14 | 9.1 |
| Cl | 0.24 | 90.66 | 91.81 | 14.03 | 10.9 | 14.05 | 14.49 |
| Zr | 1.16 | 0.46 | — | 43.7 | 46.71 | 48.46 | 47.35 |
| Total | 100 | 100 | 100 | 100 | 100 | 100 | 100 |

In addition, the produced cell was subjected to a first charging and a first discharging, and the cycle characteristics of the cell were determined. In the first charging, charging at a constant current and constant voltage was carried out at 0.05 C up to 4.2 V at 25° C., In the first discharging, discharging at a constant current was carried out at 0.05 C up to 2.5 V at 25° C.

It is noted that 1 C is a current value that allows full charging or full discharging in one hour. For example, 0.5 C is a current value that allows full charging or full discharging in two hours.

The cycle characteristics were measured using a battery test device for secondary battery charging and discharging (manufactured by HOKUTO DENKO Corporation). The cycle characteristics were evaluated in an environment of 25° C. The cycle characteristics were evaluated by carrying out charging and discharging under the following conditions. Charging at a constant current and constant voltage was carried out at 0.5 C up to 4.2 V. and subsequently, charging at a constant voltage was carried out until the current value reached 0.05 C while maintaining 4.2 V. Next, discharging at a constant current was carried out at 1 C up to 2.5 V, Under these conditions, the charging and discharging cycle was repeated 10 times, and the discharge capacity in each cycle was compared to evaluate the cycle characteristics.

### Example 2

A cell was produced in the same manner as in Example 1, except that the powder used as the solid electrolyte was changed to a Li₂ZrSO₄Cl₄ powder.

### Evaluation

The all-solid-state battery produced by the above-described procedure was sliced in an environment not exposed to the atmospheric air, and then an electron microscope image was obtained using a transmission electron microscope (TEM). In the TEM image of the negative electrode mixture layer of the all-solid-state battery of Example 2, four layers were confirmed in the lamination direction, as in Example 1, and as a result of the compositional analysis and the elemental analysis described later, it was confirmed that these four layers were a layer of a negative electrode active material, a first phase, a second phase, and a layer of a solid electrolyte (corresponding to the reference numeral 34E in FIG. 2). In Example 2, the elemental analysis and the compositional analysis were carried out with the same method as in Example 1 by STEM-EDS using a TEM, the presence of Li was checked by STEM-EELS, and the crystallinity was evaluated by TEM-ED. In addition, the produced all-solid-state battery was subjected to a first charging and a first discharging and the cycle characteristics of the cell were determined under the same conditions as in Example 1. The first discharge capacity of the all-solid-state battery and the cycle characteristics of the all-solid-state battery after 10 cycles were determined.

### Example 3

In Example 3, an all-solid-state battery was produced and evaluated in the same manner as in Example 2, except that the solid electrolyte was changed to Li₃YCl₆.

### Example 4 to Example 6

In Example 4, an all-solid-state battery was produced and evaluated in the same manner as in Example 2, except that Li₂ZrSO₄Cl_{3.9}F_{0.1} was used as the solid electrolyte, the ratio of LiCl relative to graphite was changed to 0.4875 (wt %), and that LiF was added together with LiCl at a ratio of 0.0125 (wt %) relative to graphite.

In Example 5, an all-solid-state battery was produced and evaluated in the same manner as in Example 2, except that Li₂ZrSO₄Cl_{3.9}Br_{0.1} was used as the solid electrolyte, the ratio of LiCl relative to graphite was changed to 0.4875 (wt %), and LiBr was added together with LiCl at a ratio of 0.0125 (wt %) relative to graphite.

In Example 6, an all-solid-state battery was produced and evaluated in the same manner as in Example 2, except that Li₂ZrSO₄Cl_{3.8}I_{0.2} was used as the solid electrolyte, the ratio of LiCl to relative graphite was changed to 0.4875 (wt %), and LiI was added together with LiCl at a ratio of 0.0125 (wt %) relative to graphite.

### Example 7 to Example 13

In Example 7, an all-solid-state battery was produced and evaluated in the same manner as in Example 2, except that the solid electrolyte was changed to Li₂ZrCO₃Cl₄.

In Example 8, an all-solid-state battery was produced and evaluated in the same manner as in Example 2, except that the solid electrolyte was changed to Li_{1.5}Zr(BO₃)_{0.5}Cl₄.

In Example 9, an all-solid-state battery was produced and evaluated in the same manner as in Example 2, except that the solid electrolyte was changed to Li_{1.5}Zr(PO₄)_{0.5}Cl₄.

In Example 10, an all-solid-state battery was produced and evaluated in the same manner as in Example 2, except that the solid electrolyte was changed to Li₂Zr(NO₃)Cl₅.

In Example 11, an all-solid-state battery was produced and evaluated in the same manner as in Example 2, except that the solid electrolyte was changed to Li₂ZrSiO₃Cl₄.

In Example 12, an all-solid-state battery was produced and evaluated in the same manner as in Example 2, except that the solid electrolyte was changed to Li₂ZrOHCl₅.

In Example 13, an all-solid-state battery was produced and evaluated in the same manner as in Example 2, except that the solid electrolyte was changed to Li₂ZrOCl₄.

### Example 14

In Example 14, an all-solid-state battery was produced and evaluated in the same manner as in Example 2, except that the heat treatment temperature of the sealed cell was changed to 40° C.

### Example 15 to Example 17

In Example 15, an all-solid-state battery was produced and evaluated in the same manner as in Example 2, except that the solid electrolyte was changed to Li_{2.3}Zr_{0.9}Cs_{0.1}OCl₄.

In Example 16, an all-solid-state battery was produced and evaluated in the same manner as in Example 2, except that the solid electrolyte was changed to Li_{2.2}Zr_{0.9}Ba_{0.1}OCl₄.

In Example 17, an all-solid-state battery was produced and evaluated in the same manner as in Example 2, except that the solid electrolyte was changed to Li_{2.2}Zr_{0.9}Ca_{0.1}OCl₄.

### Comparative Example 1 and Comparative Example 2

In Comparative Example 1, an all-solid-state battery was produced and evaluated in the same manner as in Example 2, except that in “(2-2) Preparation of negative electrode mixture”, lithium chloride was not added and the heat treatment step was not carried out.

In Comparative Example 2, an all-solid-state battery was produced and evaluated in the same manner as in Example 2, except that the heat treatment step was not carried out.

### Comparative Example 3 and Comparative Example 4

In Comparative Example 3, an all-solid-state battery was produced and evaluated in the same manner as in Example 3, except that in “(2-2) Preparation of negative electrode mixture”, lithium chloride was not added and the heat treatment step was not carried out.

In Comparative Example 4, an all-solid-state battery was produced and evaluated in the same manner as in Example 3, except that the heat treatment step was not carried out.

### Comparative Example 5 and Comparative Example 6

In Comparative Example 5, an all-solid-state battery was produced and evaluated in the same manner as in Example 1, except that in “(2-2) Preparation of negative electrode mixture”, lithium chloride was not added and the heat treatment step was not carried out.

In Comparative Example 6, an all-solid-state battery was produced and evaluated in the same manner as in Example 1, except that the heat treatment step was not carried out.

### Comparative Example 7 to Comparative Example 13

In Comparative Example 7, an all-solid-state battery was produced and evaluated in the same manner as in Example 4, except that in “(2-2) Preparation of negative electrode mixture”. LiCl and LiF were not added and the heat treatment step was not carried out.

In Comparative Example 8, an all-solid-state battery was produced and evaluated in the same manner as in Example 4, except that the ratio of LiCl relative to graphite was changed to 0.5 (wt %). LiF was not added, and the heat treatment step was not carried out.

In Comparative Example 9, an all-solid-state battery was produced and evaluated in the same manner as in Example 5, except that in “(2-2) Preparation of negative electrode mixture”. LiCl and LiBr were not added and the heat treatment step was not carried out.

In Comparative Example 10, an all-solid-state battery was produced and evaluated in the same manner as in Example 5, except that the ratio of LiCl relative to graphite was changed to 0.5 (wt %). LiBr was not added, and the heat treatment step was not carried out.

In Comparative Example 11, an all-solid-state battery was produced and evaluated in the same manner as in Example 6, except that in “(2.2) Preparation of negative electrode mixture”, LiCl and LiI were not added, and the heat treatment step was not carried out.

In Comparative Example 12, an all-solid-state battery was produced and evaluated in the same manner as in Example 6, except that the ratio of LiCl relative to graphite was changed to 0.5 (wt %). LiI was not added, and the heat treatment step was not carried out.

The production conditions for the all-solid-state battery of each of Example 1 to Example 17 and Comparative Example 1 to Comparative Example 12 are summarized in Table 2 and Table 3.

In addition, the evaluation results of the all-solid-state battery of each of Example 1 to Example 17 and Comparative Example 1 to Comparative Example 12 are summarized in Table 4 to Table 6.

In Examples 1 to 17, the presence of both the first intermediate phase and the second intermediate phase was confirmed.

TABLE 2

| | | Ratio of LiX (1) | | Amount of | | | |
|---|---|---|---|---|---|---|---|
| | LiX (1) | added to negative | LiX (2) | LiX (2) added | Temperature | | |
| | added to | electrode mixture | added to | to negative | of heat | Time for heat | |
| | negative | relative to weight | negative | electrode | treatment of | treatment of | |
| | electrode | of active material | electrode | mixture | sealed cell | sealed cell | Solid |
| | mixture | [wt %] | mixture | [g] | [%] | [hour] | electrolyte |
| Example 1 | LiCl | 0.5 | — | — | 45 | 1 | Li2ZrCl6 |
| Example 2 | LiCl | 0.5 | — | — | 45 | 1 | Li2ZrSO4Cl4 |
| Example 3 | LiCl | 0.5 | — | — | 45 | 1 | Li3YCl6 |
| Example 4 | LiCl | 0.4875 | LiF | 0.0125 | 45 | 1 | Li2ZrSO4Cl3.9F0.1 |
| Example 5 | LiCl | 0.4875 | LiBr | 0.0125 | 45 | 1 | Li2ZrSO4Cl3.9Br0.1 |
| Example 6 | LiCl | 0.4875 | LiI | 0.0125 | 45 | 1 | Li2ZrSO4Cl3.8I0.2 |
| Example 7 | LiCl | 0.5 | — | — | 45 | 1 | Li2ZrO3Cl4 |
| Example 8 | LiCl | 0.5 | — | — | 45 | 1 | Li1.5Zr(BO3)0.5Cl4 |
| Example 9 | LiCl | 0.5 | — | — | 45 | 1 | Li1.5Zr(PO4)0.5Cl4 |
| Example 10 | LiCl | 0.5 | — | — | 45 | 1 | Li2Zr(NO3)Cl5 |
| Example 11 | LiCl | 0.5 | — | — | 45 | 1 | Li2ZrSiO3Cl4 |
| Example 12 | LiCl | 0.5 | — | — | 45 | 1 | Li2ZrOHCl5 |
| Example 13 | LiCl | 0.5 | — | — | 45 | 1 | Li2ZrOCl4 |
| Example 14 | LiCl | 0.5 | — | — | 40 | 0.5 | Li2ZrSO4Cl4 |
| Example 15 | LiCl | 0.5 | — | — | 45 | 1 | Li2.3Zr0.9Cs0.1OCl4 |
| Example 16 | LiCl | 0.5 | — | — | 45 | 1 | Li2.2Zr0.9Ba0.1OCl4 |
| Example 17 | LiCl | 0.5 | — | — | 45 | 1 | Li2.2Zr0.9Ca0.1OCl4 |

TABLE 3

| | LiX (1) added to | Amount of LiX (1) | Temperature of heat | Time for heat | |
|---|---|---|---|---|---|
| | negative electrode | added to negative | treatment of sealed cell | treatment of sealed | Solid |
| | mixture | electrode mixture [g] | [° C.] | cell [hour] | electrolyte |
| Comparative | — | — | — | — | Li2ZrSO4Cl4 |
| Example 1 | | | | | |
| Comparative | LiCl | 0.5 | — | — | Li2ZrSO4Cl4 |
| Example 2 | | | | | |
| Comparative | — | — | — | — | Li3YCl6 |
| Example 3 | | | | | |
| Comparative | LiCl | 0.5 | — | — | Li3YCl6 |
| Example 4 | | | | | |
| Comparative | — | — | — | — | Li2ZrCl6 |
| Example 5 | | | | | |
| Comparative | LiCl | 0.5 | — | — | Li2ZrCl6 |
| Example 6 | | | | | |
| Comparative | — | — | — | — | Li2ZrSO4Cl3.9F0.1 |
| Example 7 | | | | | |
| Comparative | LiCl | 0.5 | — | — | Li2ZrSO4Cl3.9F0.1 |
| Example 8 | | | | | |
| Comparative | — | — | — | — | Li2ZrSO4Cl3.9Br0.1 |
| Example 9 | | | | | |
| Comparative | LiCl | 0.5 | — | — | Li2ZrSO4Cl3.9Br0.1 |
| Example 10 | | | | | |
| Comparative | — | — | — | — | Li2ZrSO4Cl3.8I0.2 |
| Example 11 | | | | | |
| Comparative | LiCl | 0.5 | — | — | Li2ZrSO4Cl3.8I0.2 |
| Example 12 | | | | | |

TABLE 4

| | | | | Second phase | | | | |
|---|---|---|---|---|---|---|---|---|
| | First phase | | | Ratio of X | | | | |
| | Ratio of X | | | element | | | | |
| | element | | | concentration | | | | |
| | concentration | | | in second | | | | |
| | in first phase | | | phase to X | Ratio of X | Ratio of E | Ratio of G | Ratio of D |
| | to X element | | | element | element | element | element | element |
| | concentration | Presence or | Presence or | concentration | concentration | concentration | concentration | concentration |
| | in solid | absence of | absence of | in solid | relative to | relative to | relative to | relative to |
| | electrolyte | Li element | crystallinity | electrolyte | first phase | first phase | first phase | first phase |
| Example 1 | 5.55 | Present | Present | 0.77 | 0.14 | 1.20 | — | — |
| Example 2 | 6.33 | Present | Present | 0.75 | 0.12 | 1.11 | — | 4.73 |
| Example 3 | 5.01 | Present | Present | 0.78 | 0.16 | 1.10 | — | — |
| Example 4 | 4.01 | Present | Present | 0.79 | 0.20 | 1.35 | — | — |
| Example 5 | 4.33 | Present | Present | 0.81 | 0.19 | 1.28 | — | — |
| Example 6 | 4.24 | Present | Present | 0.75 | 0.18 | 1.15 | — | — |
| Example 7 | 6.22 | Present | Present | 0.66 | 0.11 | 1.25 | — | 2.11 |
| Example 8 | 4.11 | Present | Present | 0.71 | 0.17 | 1.18 | — | 3.59 |
| Example 9 | 5.65 | Present | Present | 0.68 | 0.12 | 1.22 | — | 4.52 |
| Example 10 | 2.05 | Present | Present | 0.91 | 0.44 | 1.31 | — | 2.34 |
| Example 11 | 1.82 | Present | Present | 0.92 | 0.51 | 1.28 | — | 3.50 |
| Example 12 | 3.21 | Present | Present | 0.91 | 0.28 | 1.33 | — | 1.10 |
| Example 13 | 2.68 | Present | Present | 0.89 | 0.33 | 1.26 | — | 2.98 |
| Example 14 | 3.52 | Present | Absent | 0.93 | 0.26 | 1.11 | — | 3.87 |
| Example 15 | 2.01 | Present | Present | 0.88 | 0.44 | 1.10 | 1.25 | 2.54 |
| Example 16 | 1.88 | Present | Present | 0.92 | 0.49 | 1.12 | 1.21 | 2.33 |
| Example 17 | 1.85 | Present | Present | 0.91 | 0.49 | 1.11 | 1.18 | 2.43 |

TABLE 5

Electric characteristics

| | | Cycle characteristics |
|---|---|---|
| | First discharge | Capacity retention rate after |
| | capacity (mAh/g) | 10 cycles (%) |
| Example 1 | 349 | 94.8 |
| Example 2 | 341 | 95.6 |
| Example 3 | 355 | 94.5 |
| Example 4 | 344 | 95.0 |
| Example 5 | 341 | 94.8 |
| Example 6 | 344 | 94.5 |
| Example 7 | 353 | 95.1 |
| Example 8 | 365 | 94.2 |
| Example 9 | 341 | 95.1 |
| Example 10 | 344 | 94.4 |
| Example 11 | 343 | 94.3 |
| Example 12 | 346 | 94.0 |
| Example 13 | 351 | 94.8 |
| Example 14 | 345 | 93.5 |
| Example 15 | 348 | 94.2 |
| Example 16 | 342 | 93.1 |
| Example 17 | 341 | 93.1 |

TABLE 6

| | First phase | | | | Second | | |
|---|---|---|---|---|---|---|---|
| | | Ratio of X element | | | phase | Electric characteristics | |
| | | concentration in first | | | Presence or | First | Cycle characteristics |
| | Presence or | phase to X element | Presence or | Presence or | absence of | discharge | Capacity retention |
| | absence of | concentration in solid | absence of | absence of | second | capacity | rate after 10 cycles |
| | first phase | electrolyte | Li element | crystallinity | phase | (mAh/g) | (%) |
| Comparative | Absent | — | — | — | Absent | 274 | 85.1 |
| Example 1 | | | | | | | |
| Comparative | Present | 6.21 | Present | Present | Absent | 308 | 90.1 |
| Example 2 | | | | | | | |
| Comparative | Absent | — | — | — | Absent | 288 | 83.9 |
| Example 3 | | | | | | | |
| Comparative | Present | 4.99 | Present | Present | Absent | 301 | 89.1 |
| Example 4 | | | | | | | |
| Comparative | Absent | — | — | — | Absent | 297 | 84.9 |
| Example 5 | | | | | | | |
| Comparative | Present | 5.31 | Present | Present | Absent | 304 | 89.3 |
| Example 6 | | | | | | | |
| Comparative | Absent | — | — | — | Absent | 279 | 85.6 |
| Example 7 | | | | | | | |
| Comparative | Present | 4.06 | Present | Present | Absent | 310 | 88.6 |
| Example 8 | | | | | | | |
| Comparative | Absent | — | — | — | Absent | 248 | 86.2 |
| Example 9 | | | | | | | |
| Comparative | Present | 4.38 | Present | Present | Absent | 303 | 89.5 |
| Example 10 | | | | | | | |
| Comparative | Absent | — | — | — | Absent | 222 | 87.1 |
| Example 11 | | | | | | | |
| Comparative | Present | 4.22 | Present | Present | Absent | 299 | 88.7 |
| Example 12 | | | | | | | |

Those having an experimental result of 0 are indicated by “-” in the tables. As shown in Table 4 to Table 6, in Example 2 to Example 14, it has been confirmed that the X element concentration in the first phase was higher than the X element concentration in the solid electrolyte layer, and the X element concentration in the second phase was lower than the X element concentration in the first phase and the X element concentration in the solid electrolyte layer. In addition, it has been confirmed that the E element concentration in the second phase was higher than the E element concentration in the first phase in Example 2 to Example 14, and it has been confirmed that the D group concentration in the second phase was higher than the D) group concentration in the first phase and the D group concentration in the solid electrolyte layer in Example 2 and Example 7 to Example 14. It has been confirmed that the G element concentration in the second phase was higher than the G element concentration in the first phase and the G element concentration in the solid electrolyte layer in Example 15 to Example 17.

Although Table 4 does not show the data on the D group concentration and the G element concentration in the solid electrolyte layer, the line analysis of the solid electrolyte layer was carried out by STEM-EDS according to the above-described method, and the X element concentration, the D group concentration, and the G element concentration in the solid electrolyte layer were measured.

As a result of the measurements, the above-described matters were confirmed.

In addition, in Example 1 to Example 17 which included the first phase 34B and the second phase 34C, it has been confirmed that the first discharge capacity and the cycle characteristics after 10 cycles were high as compared with Comparative Example 1 to Comparative Example 12 which included neither the first phase 34B nor the second phase 34C.

### INDUSTRIAL APPLICABILITY

The all-solid-state battery according to the present embodiment can be suitably applied as a secondary battery for portable electronic devices such as a smartphone and a notebook-sized personal computer, and as a storage battery for automobiles or industrial equipment.

### REFERENCE SIGNS LIST

10 Solid electrolyte layer
20 Positive electrode layer
22 Positive electrode current collector
24 Positive electrode mixture layer
30 Negative electrode layer
32 Negative electrode current collector
34 Negative electrode mixture layer
34A Negative electrode active material
34B First phase
34C Second phase
34D Carbon material
40 Power generation element
50 Exterior body
52 Metal foil
54 Resin layer
60, 62 Terminal
100 All-solid-state battery

1. An all-solid-state battery comprising:
a power generation element in which a positive electrode layer, a solid electrolyte layer containing a halide-based solid electrolyte represented by Formula (1), and a negative electrode layer are laminated in this order,
wherein the negative electrode layer includes a negative electrode current collector and a negative electrode mixture layer provided on a surface of the negative electrode current collector, the surface facing the positive electrode layer,
the negative electrode mixture layer contains either one or both of a negative electrode active material and a carbon material, a first phase in contact with at least a part of the negative electrode active material and the carbon material, and a second phase in contact with at least a part of the first phase,
the first phase and the second phase contain a Li element and an X element which is at least one halogen element selected from the group consisting of F, Cl, Br, and I,
an X element concentration in the first phase is higher than an X element concentration in the solid electrolyte layer, and
an X element concentration in the second phase is lower than the X element concentration in the first phase and the X element concentration in the solid electrolyte layer, 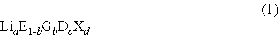
(In Formula (1), B is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Ti, Cu, Nb, Ag, In, Sn, Sb, Ta, W, Au, and Bi, D is at least one group selected from the group consisting of CO, SO₄, BO₃, PO₄, NO₃, SiO₃, OH, and O₂, X is at least one selected from the group consisting of F, Cl, Br, and I, and the following expressions are satisfied: 2≤a<3.5, 0≤b<0.5, 0≤c≤5, and 0<d≤6.1.)

2. The all-solid-state battery according to claim 1,
wherein the first phase and the second phase further contain an E element which is at least one element selected from the group consisting of Al, Sc, Y, Zr, Hf, and lanthanoids, and
an E element concentration in the second phase is higher than an E element concentration in the first phase.

3. The all-solid-state battery according to claim 1,
wherein the first phase and the second phase further contain a G element which is at least one element selected from the group consisting of Na, K, Rb, Cs, Mg, Ca, Sr, Ba, B, Si, Ti, Cu, Nb, Ag, In, Sn, Sb, Ta, W, Au, and Bi, and
a G element concentration in the second phase is higher than G element concentrations in the first phase and the solid electrolyte layer.

4. The all-solid-state battery according to claim 1,
wherein the first phase and the second phase further contain a D group which is at least one anion selected from the group consisting of CO₃, SO₄, BO₃, PO₄, NO₃, SiO₃, OH, and O₂, and
a D group concentration in the second phase is higher than D group concentrations in the first phase and the solid electrolyte layer.

5. The all-solid-state battery according to claim 1,
wherein each of the first phase and the second phase has a layered structure,
the first phase covers either one or both of the negative electrode active material and the carbon material, and
the second phase covers the first phase.

6. The all-solid-state battery according to claim 1,
wherein the negative electrode active material is at least one selected from graphite, Si, SiOₓ, lithium titanate, and metallic lithium.

7. The all-solid-state battery according to claim 1,
wherein the carbon material is at least one selected from carbon black, graphite, a carbon nanotube, and graphene.

8. The all-solid-state battery according to claim 1,
wherein the negative electrode mixture layer contains the solid electrolyte, and
the second phase is provided between the first phase and the solid electrolyte.
